(19) United States
(12) Patent Application Publication
(10) Pub. No.: US 2010/0127028 A1
(43) Pub. Date: May 27, 2010

(54) ARTICLE HOLDER MOUNTABLE TO CONTAINER OF WHEELBARROW

(76) Inventor: Michael Lusk, Naples, FL (US)

Correspondence Address: JAY M. SCHLOFF, 6960 Orchard Lake Road, Suite 315, West Bloomfield, MI, 48322, US

(21) Appl. No.: 12/537,752

(22) Filed: Aug. 7, 2009

Related U.S. Application Data
(60) Provisional application No. 61/117,981, filed on Nov. 26, 2008.

(51) Int. Cl. B60R 11/06

(52) U.S. Cl. 224/401; 224/42.11; 224/538

(57) ABSTRACT

An article holder for a wheelbarrow includes at least one holding member and at least one strap member. Each of the at least one holding member includes a body member, an attaching member, a plurality of hollow compartments and a support member. The body member may be removably attached to a sidewall of the container of the wheelbarrow via the attaching member. The plurality of hollow compartments is disposed on the body member for receiving articles therein. The support member is disposed on the body member for supporting to the body member on the container. Further, each of the at least one strap member includes a first end portion and a second end portion. The first end portion is capable of being attached to a holding member of the at least one holding member. The second end portion is capable of securing the holding member to the wheelbarrow.

### CROSS-REFERENCE TO RELATED APPLICATIONS

The present disclosure claims priority under 35 United States Code, Section 119 on the U.S. Provisional Patent Application No. 61/117,981 filed on Nov. 26, 2008, the disclosure of which is incorporated by reference.

### FIELD OF THE DISCLOSURE

The present disclosure generally relates to wheelbarrows, and more particularly, to an article holder for a wheelbarrow to hold articles, such as shovels and rakes, therein.

### BACKGROUND OF THE DISCLOSURE

Wheelbarrows are employed during various activities, such as gardening and landscaping, for carrying loads, such as gardening and landscaping waste, from one location to another location. Generally, a wheelbarrow includes a container supported over a wheel arrangement. Further, the wheelbarrow includes handles for maneuvering and dumping the container filled with such loads. Conventionally, while employing the wheelbarrow during such activities, individuals may also need to carry tools, such as shovels and rakes, for performing tasks related to such activities.

Generally, such tools are placed on the wheelbarrow within reach of the individuals. Usually, the individuals place such tools in the container of the wheelbarrow for keeping the tools within reach. Placement of the tools in the container results in damaging of the tools due to jostling in the container. Moreover, placement of such tools in the container limits the container's space for storing the loads. Alternatively, the individuals may also hold such tools in his or her hands, which may increase difficulties of the individuals while maneuvering the wheelbarrow.

Accordingly, there exists a need for placement of the tools on the wheelbarrow within reach of the individuals without damaging the tools due to jostling in the container. Furthermore, there exists a need for enabling the individuals to carry the tools without a need of holding the tools in his/her hands, while allowing easy maneuvering of the wheelbarrow.

### SUMMARY OF THE DISCLOSURE

In view of the foregoing disadvantages inherent in the prior art, the general purpose of the present disclosure is to provide an article holder for a wheelbarrow that is configured to include all the advantages of the prior art, and to overcome the drawbacks inherent therein.

Accordingly, an object of the present disclosure is to provide an article holder for a wheelbarrow that is capable of facilitating placement of tools on the wheelbarrow within reach of individuals, without damaging the tools due to jostling in a container of the wheelbarrow.

Another object of the present disclosure is to provide an article holder for a wheelbarrow that enables the individuals to carry the tools without a need of holding the tools in his/her hands, while allowing easy maneuvering of the wheelbarrow.

To achieve the above objects, in an aspect of the present disclosure, an article holder for a wheelbarrow is provided. The wheelbarrow comprises a container to which the article holder may be attached. The article holder includes at least one holding member and at least one strap member. Each of the at least one holding member includes a body member, an attaching member, a plurality of hollow compartments and a support member. The body member has a front surface, and a rear surface opposite to the front surface. The attaching member is coupled to the body member for removably attaching the body member to an edge of the container of the wheelbarrow. The plurality of hollow compartments is disposed in a tilted orientation on the front surface of the body member. The plurality of hollow compartments is capable of receiving articles therein. The support member is disposed on the rear surface of the body member. The support member is capable supporting of the body member on a sidewall of the container of the wheelbarrow. Further, each of the at least one strap member includes a first end portion, and a second end portion opposite to the first end portion. The first end portion is capable of being attached to a holding member of the at least one holding member. The second end portion is capable of securing the holding member of the at least one holding member to the wheelbarrow.

The article holder upon being attached to the wheelbarrow facilitates placement of the articles, such as shovels and rakes, in the plurality of hollow compartments disposed on the front surface of the body member so that the articles may be within reach of the individuals. Such placement of the articles in the plurality of hollow compartments precludes damaging of the articles due to jostling in the container. Further, the article holder enables the individuals to carry the articles without a need of holding the articles in his/her hands, thereby facilitating easy maneuvering of the wheelbarrow.

This together with the other aspects of the present disclosure, along with the various features of novelty that characterized the present disclosure, is pointed out with particularity in the claims annexed hereto and forms a part of the present disclosure. For a better understanding of the present disclosure, its operating advantages, and the specified objects attained by its uses, reference should be made to the accompanying drawings and descriptive matter in which there are illustrated exemplary embodiments of the present disclosure.

### BRIEF DESCRIPTION OF THE DRAWINGS

The advantages and features of the present disclosure will become better understood with reference to the following detailed description and claims taken in conjunction with the accompanying drawings, in which:

FIG. 1 illustrates a perspective view of an article holder, in accordance with an embodiment of the present disclosure;

FIG. 2A illustrates a perspective view of an arrangement depicting the article holder in utilized state with a wheelbarrow, in accordance with an embodiment of the present disclosure; and

FIG. 2B illustrates a bottom view of the arrangement of FIG. 2A depicting the article holder in utilized state with the wheelbarrow, in accordance with an embodiment of the present disclosure.

Like reference numerals refer to like parts throughout the description of several views of the drawings.

### DETAILED DESCRIPTION OF THE DISCLOSURE

For a thorough understanding of the present disclosure, reference is to be made to the following detailed description, including the appended claims, in connection with the above-described drawings. Although the present disclosure is described in connection with exemplary embodiments, the present disclosure is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The terms “first,” “second,” “third,” “front,” “rear,” “top,” “bottom,” and the like, herein do not denote any order, elevation or importance, but rather are used to distinguish placement of one element over another. The terms “a” and “an” herein do not denote a limitation of quantity, but rather denote the presence of at least one of the referenced item.

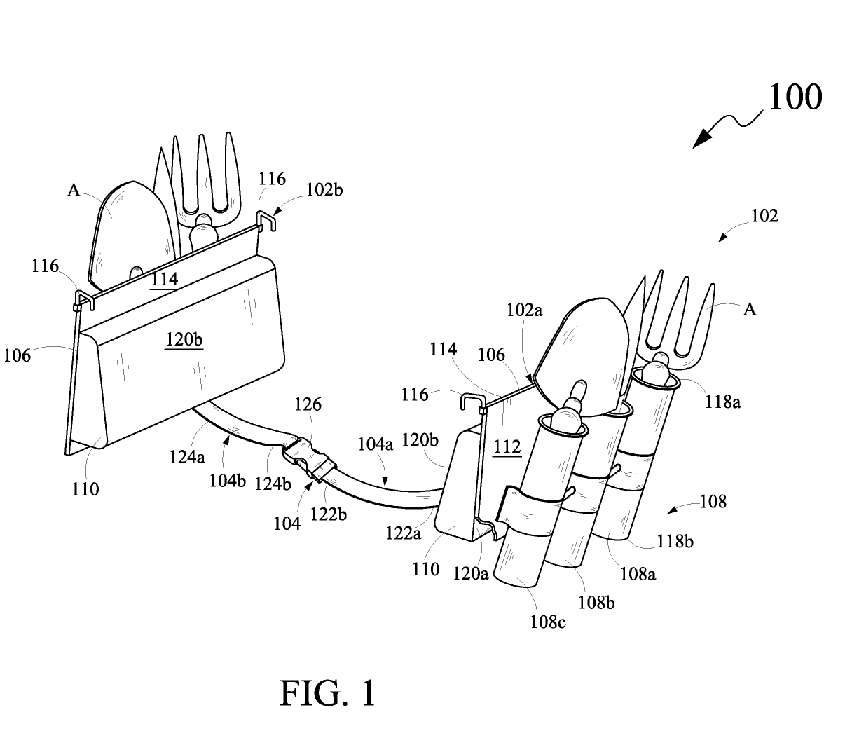

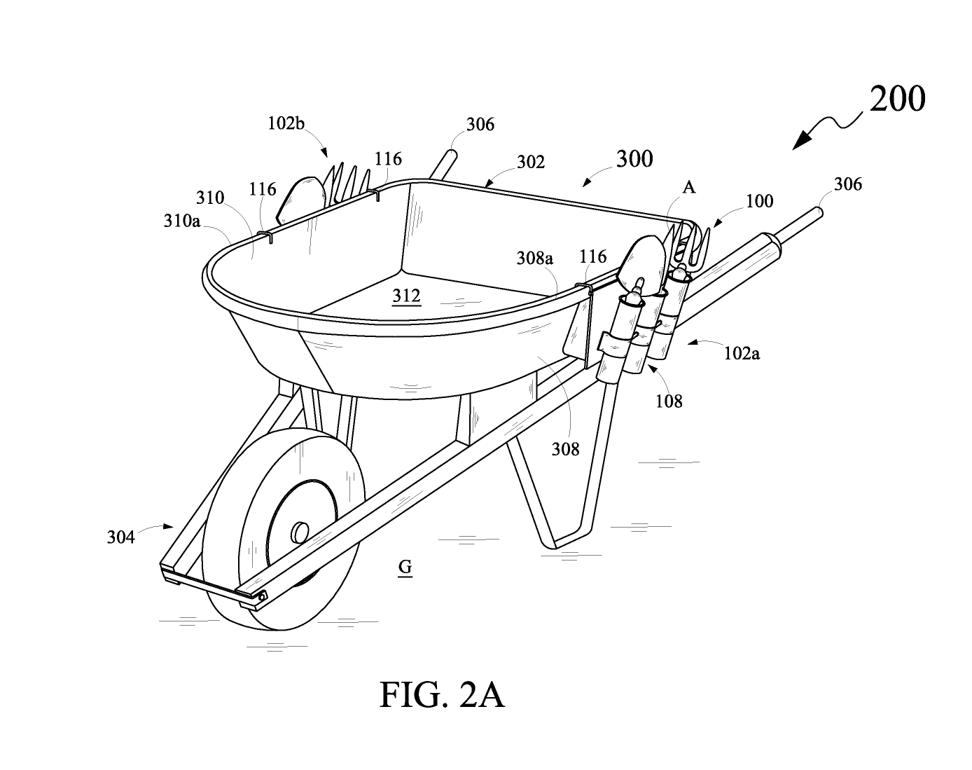

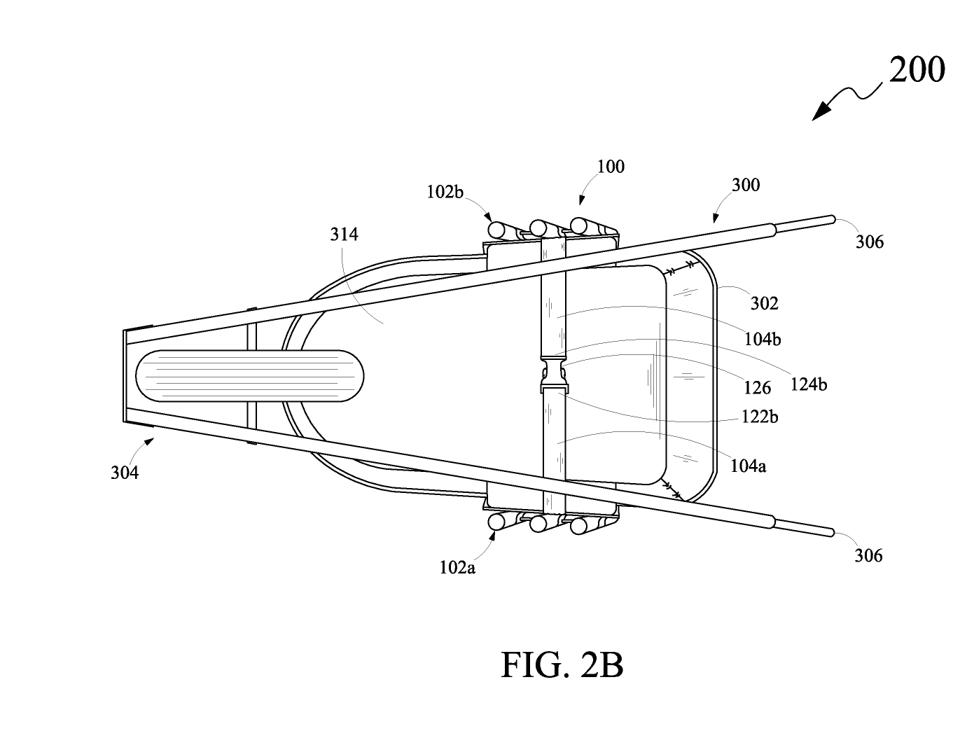

Referring now to FIG. 1, an article holder 100 for a wheelbarrow (shown in FIGS. 2A and 2B) is illustrated, in accordance with an embodiment of the present disclosure. The article holder 100 includes at least one holding member and at least one strap member attached to the at least one holding member. In an exemplary embodiment of the present disclosure, the at least one holding member is shown to include two holding members, such as a first holding member 102a and a second holding member 102b. Further, in such embodiment of the present disclosure, the at least one strap member is shown to include two strap members, such as a first strap member 104a and a second strap member 104b. However, without departing from the scope of the present disclosure, in one embodiment, the article holder 100 may include one holding member, such as the first holding member 102a or the second holding member 102b, and one strap member, such as the first strap member 104a or the second strap member 104b.

In the present embodiment of the disclosure, the first strap member 104a is attached to the first holding member 102a, and the second strap member 104b is attached to the second holding member 102b for configuring the article holder 100, which will be described in conjunction with FIGS. 1, 2A and 2B. Hereinafter, the first holding member 102a and the second holding member 102b will be also collectively referred to as ‘holding member 102,’ and the first strap member 104a and the second strap member 104b will be also collectively referred to as ‘strap member 104.

As shown in FIG. 1, the holding member 102 includes a body member 106, a plurality of hollow compartments, such as a first compartment 108a, a second compartment 108b and a third compartment 108c (hereinafter collectively referred to as ‘compartments 108’) and a support member 110. The body member 106 has a front surface 112 and a rear surface 114 opposite to the front surface 112. Further, the holding member 102 includes an attaching member 116. The attaching member 116 is coupled to an edge of a container (shown in FIGS. 2A and 2B) of the wheelbarrow for removably attaching the body member 106 to the wheelbarrow, thereby attaching the holding member 102 to the wheelbarrow. In an embodiment of the present disclosure, the attaching member 116 is at least one hook arrangement disposed on a periphery of the body member 106. Particularly, the at least one hook arrangement may include a pair of hooks disposed in a spaced apart manner at corners of the periphery of the body member 106 for enabling attaching of the holding member 102 to the wheelbarrow. However, without departing from the scope of the present disclosure, the attaching member 116 may include a hook and loop fastener, a snap fit arrangement, a nut and bolt arrangement, as know in the art, for facilitating attachment of the body member 106 to the wheelbarrow. The body member 106 may be composed of a durable material, such as a canvas material. Further, the body member 106 may be made of different colors so as to accommodate various individual preferences. Furthermore, the compartments 108 are disposed on the body member 106.

The compartments 108 are disposed in a tilted orientation on the front surface 112 of the body member 106. Each compartment, such as the first compartment 108a, the second compartment 108b and the third compartment 108c, includes an open top portion 118a and a closed bottom portion 118b. Further, the each of the compartments 108 converges from the open top portion 118a towards the closed bottom portion 108b for configuring a converging hollow space (not shown) to receive articles ‘A’ therein. The converging hollow space of each of the compartments 108 is capable of receiving the articles ‘A’ in a manner such that falling off of the articles ‘A’ from the compartments 108 are minimized. For example, the articles ‘A’ may be snugly received in the compartments 108, thereby minimizing falling off of the articles ‘A’ from the compartments 108, when the wheelbarrow is maneuvered or dumped. Further, the tilted orientation of the compartments 108 on the body member 106 provides an added benefit in minimizing falling off of the articles ‘A’ from the compartments 108, when the wheelbarrow is maneuvered or dumped. The articles ‘A’ received in the compartments 108 may include, but not limited to, shovels, rakes and the like. The compartments 108 may be composed of durable material, such as a wooden material, a plastic material and metal alloys. Furthermore, the support member 110 is disposed on the rear surface 114 opposite to the front surface 112 of the body member 106.

The support member 110 includes a first face 120a and a second face 120b. The second face 120b is positioned in a slanted manner opposite the first face 120a of the support member 110. Further, the first face 120a of the support member 110 is disposed on the rear surface 114 of the body member 106 for attaching the support member 110 to the body member 106. In an embodiment of the present disclosure, the first surface 120a of the support member 110 may be permanently attached to the rear surface 114 of the body member 106 by a gluing method and the like. However, the first face 120a of the support member 110 may be removably attached to the rear surface 114 of the body member 106 by processes known in the art. Further, the second face 120b of the support member 110 is capable of resting on a sidewall of the container of the wheelbarrow. Particularly, the support member 110 enables resting of the body member 106 on the wheelbarrow in a substantially vertical orientation with respect a ground surface. Such an orientation of the body member 106 with respect to the ground surface will be described with respect to FIGS. 2A and 2B. In an embodiment of the present disclosure, the support member 110 is composed of material, such as a wooden material and a plastic material. As mentioned above, the holding member 102 includes the strap member 104 attached to the body member 106 for securing the body member 106 to the wheelbarrow.

As shown in FIG. 1, the strap member 104 includes the first end portion, and the second end portion opposite to the first end portion. For example, the first strap member 104a includes a first end portion 122a and a second end portion 122b opposite to the first end portion 122a. Similarly, the second strap member 104b includes a first end portion 124a and a second end portion 124b opposite to the first end portion 124a. The first end portion 122a of the first strap member 104a is attached to the first holding member 102a. Similarly, the first end portion 124a of the second strap member 104b is attached to the second holding member 102b. Further, the second end portion 122b and the second end portion 124b are capable of securing the article holder 100 to the wheelbarrow.

In one embodiment of the present disclosure, the second end portion 122b of the first strap member 104a is connected to the second end portion 124b of the second strap member 104b by a snap fit arrangement 126 for securing the article holder 100 to the wheelbarrow. However, in another embodiment of the present disclosure, where an article holder is configured to include one holding member, such as the first holding member 102a or the second holding member 102b, and one strap member, such as the first strap member 104a or the second strap member 104b. In such embodiment of the article holder, a second end portion of such strap member may be attached to a bottom portion of the wheelbarrow by bolting arrangement for securing such article holder to the wheelbarrow. The strap member 104 may be composed of a durable material, such as a nylon material. The article holder 100, in utilized state with the wheelbarrow will be described in conjunction with FIGS. 2A and 2B.

FIGS. 2A and 2B illustrate an arrangement 200 depicting the article holder 100 in a utilized state, in accordance with an embodiment of the present disclosure. Specifically, FIG. 2A illustrates a perspective view of the arrangement 200 depicting the article holder 100 in utilized state with a wheelbarrow 300, and FIG. 2B illustrates a bottom view of the arrangement 200 depicting the article holder 100 in utilized state with the wheelbarrow 300. Herein, reference of FIG. 1 will be taken to describe the utility of the article holder 100 with respect to the wheelbarrow 300.

As shown in FIGS. 2A and 2B, the wheelbarrow 300 includes a container 302 supported over a wheel arrangement 304 having a pair of handles 306. The wheelbarrow 300 is capable of being maneuvered over a ground surface ‘G’ using the pair of handles 306 attached to the wheel arrangement 304. Further as shown in FIG. 2A, the container 302 includes a pair of opposite walls, such as a first sidewall 308 and second sidewall 310 extending vertically from a base 312 of the container 302. Each sidewall, such as the first sidewall 308 and the second sidewall 310 includes a peripheral edge portion such as an edge portion 308a and an edge portion 310a thereof, respectively.

In the utilized state, as depicted in FIG. 2A, the first holding member 102a is attached to the edge portion 308a, and the second holding member 102d is attached to the edge portion 310a. More specifically, the respective attaching member 116 of the first holding member 102a and the second holding member 102d is attached to the edge portion 308a and the edge portion 310a respectively, for attaching the first holding member 102a and the second holding member 102b to the first sidewall 308 and the second sidewall 310 of the container 302. Further as shown in FIG. 2B, each strap member, such as the first strap member 104a and the second strap member 104b, is allowed to be attached with each other from a bottom side 314 of the base 312 of the container 302. Specifically, the second end portion, such as the second end portion 122b of the first strap member 104a, and the second end portion 124b of the second strap member 104b are attached to each other at the bottom side 314 of the base 312 by the snap fit arrangement 126, thereby securing the holding member 102 to the wheelbarrow 300.

Upon securing the article holder 100 in such a manner, the respective support member 110 enables securing of the respective body member 106 in a vertical orientation with respect to the ground surface ‘G’ on the respective sidewalls, such as the first sidewall 308 and the second sidewall 310 of the container 302. Furthermore, the article holder 100 is secured to the wheelbarrow 300 in such a manner that the compartments 108 are tilted towards free ends of the pair of handles 306 that may be gripped by the individuals to maneuver and dump the wheelbarrow 300. Such securing of the body member 106 in the vertical orientation with respect to the ground surface ‘G’, and the tilted orientation of the compartments 108 towards the free ends of the pair of handles 306 enable the individuals to maneuver and dump the wheelbarrow 300, thereby reducing a possibility of the articles ‘A’ falling out from the compartments 108 of the respective holding member 102. Also, the compartments 108 are positioned proximate to the free ends of the pair of handles 306, to enable the individuals to easily access the compartments 108 for locating the articles ‘A.’

The present disclosure provides an article holder, such as the article holder 100 for a wheelbarrow. The article holder is capable of being easily attached to the wheelbarrow for facilitating placement of articles, such as shovels and rakes, therein. Such placement of the articles in the article holder precludes damaging of the articles due to jostling in the container. Further, the article holder enables the individuals to carry the articles without a need of holding the articles in his/her hands, thereby facilitating easy maneuvering of the wheelbarrow.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. An article holder for a wheelbarrow, the wheelbarrow comprising a container, the article holder comprising:
at least one holding member, each of the at least one holding member comprising
a body member having a front surface and a rear surface opposite to the front surface,
an attaching member coupled to the body member for removably attaching the body member to an edge of the container of the wheelbarrow,
a plurality of hollow compartments disposed in a tilted orientation on the front surface of the body member, the plurality of hollow compartments capable of receiving articles therein, and
a support member disposed on the rear surface of the body member, the support member capable of supporting the body member on a sidewall of the container of the wheelbarrow; and
at least one strap member, each of the at least one strap member having a first end portion and a second end portion opposite to the first end portion, wherein the first end portion is capable of being attached to a holding member of the at least one holding member, and, wherein the second end portion is capable of securing the holding member of the at least one holding member to the wheelbarrow.

2. The article holder of claim 1, wherein the attaching member is at least one hook arrangement disposed on a periphery of the body member.

3. The article holder of claim 1, wherein each hollow compartment of the plurality of hollow compartments converges from an open top portion towards a closed bottom portion thereof for configuring a converging hollow space to receive the articles therein.

4. The article holder of claim 1, wherein the support member comprises:
a first face; and
a second face positioned in a slanted manner opposite to the first face, wherein the first face of the support member is disposed on the rear surface of the body member for attaching the support member to the body member, and, wherein the second face of the support member is capable of resting on the sidewall of the container of the wheelbarrow.

5. The article holder of claim 1, wherein the support member is composed of one of a wooden material and a plastic material.

6. The article holder of claim 1, wherein the body member of the each of the at least one holding member is composed of a canvas material.

7. The article holder of claim 1, wherein each of the at least one strap member is composed of a nylon material.
